(19) United States
(12) Patent Application Publication
(10) Pub. No.: US 2026/0202504 A1
(43) Pub. Date: Jul. 16, 2026

(54) METHODS AND COMMUNICATIONS NODES

(71) Applicant: Sony Group Corporation, Tokyo (JP)

(72) Inventors: Yuxin WEI, Basingstoke (GB); Vivek SHARMA, Basingstoke (GB); Hideji WAKABAYASHI, Basingstoke (GB); Yassin Aden AWAD, Basingstoke (GB)

(73) Assignee: Sony Group Corporation, Tokyo (JP)

(21) Appl. No.: 19/134,220

(22) PCT Filed: Dec. 6, 2023
(86) PCT No.: PCT/EP2023/084567

§ 371 Date: May 30, 2025

(30) Foreign Application Priority Data
Dec. 13, 2022 (EP) 22213239.1

(51) Int. Cl. G01S 7/00; G01S 13/42; G01S 13/58

(52) U.S. Cl. CPC G01S 7/006; G01S 13/42; G01S 13/58

(57) ABSTRACT

A method of joint communication and sensing is performed by a first node in a wireless network. The method includes receiving a first instance of a wireless signal from a second node, and receiving a second instance of the same signal, reflected from a sensing target. The method determines that the second instance was received within a predefined time window and/or angular range relative to the first instance. Based on comparing the two instances, the method identifies them as corresponding to the same original signal. The sensing target is then detected based on the comparison.

### BACKGROUND

### Field of Disclosure

The present disclosure relates to communications nodes and methods for joint communication and sensing.

The present application claims the Paris Convention priority of European patent application number EP22213239.1, the contents of which are hereby incorporated by reference in their entirety.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Previous generation mobile telecommunication systems, such as those based on the 3GPP defined UMTS and Long Term Evolution (LTE) architecture, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Current and future wireless communications networks are expected to routinely and efficiently support communications with an ever-increasing range of devices associated with a wider range of data traffic profiles and types than existing systems are optimised to support. For example, it is expected future wireless communications networks will be expected to efficiently support communications with devices including reduced complexity devices, machine type communication (MTC) devices, high resolution video displays, virtual reality headsets, extended Reality (XR) and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running. For example, different consideration may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario (data subject to stringent reliability and latency requirements).

In view of this there is expected to be a desire for current wireless communications networks, for example those which may be referred to as 5G or new radio (NR) systems/new radio access technology (RAT) systems, or indeed future 6G wireless communications, as well as future iterations/releases of existing systems, to efficiently support connectivity for a wide range of devices associated with different applications and different characteristic data traffic profiles and requirements.

One example of a new service is referred to as Ultra Reliable Low Latency Communications (URLLC) services which, as its name suggests, requires that a data unit or packet be communicated with a high reliability and with a low communications delay. Another example of a new service is extended Reality (XR), which may be provided by various user equipment such as wearable devices. XR combines real-world and virtual environments, incorporating aspects such as augmented reality (AR), mixed reality (MR), and virtual reality (VR), and thus requires high quality and minimised interaction delay. Services such as URLLC and XR therefore represent a challenging example for both LTE type communications systems and 5G/NR communications systems, as well as future generation communications systems.

With the expected increase in VR and XR services, and particularly with the anticipated rise in deployments of technology in areas such as Vehicle-to-X, V2X, it is anticipated that coordinated sensing will be necessary, and will increasingly be made possible by the development of the Internet of Things, IoT, and MTC devices.

### SUMMARY OF THE DISCLOSURE

The present disclosure can help address or mitigate at least some of the issues discussed above.

Example embodiments can provide a method of joint communication and sensing performed by a first communications node of a wireless communications network. The method comprises receiving a first instance of a wireless communications signal transmitted by a second communications node of the wireless communications network. The method comprises receiving a second instance of the wireless communications signal transmitted by the second communications node. The second instance of the wireless communications signal is a reflection of the wireless communications signal transmitted by the second communications node from a sensing target object. The method comprises determining that the second instance of the wireless communications signal was received by the first communications node within a predefined time window after reception of the first instance of the wireless communications signal and/or determining that the second instance of the wireless communications signal was received by the first communications node after reception of the first instance of the wireless communication signal within a predefined angular reception range. In response, the method comprises determining, based on a comparison between the first instance of the wireless communications signal and the second instance of the wireless communications signal, that the first and second instances of the wireless communications signal are instances of the same wireless communications signal. The method comprises detecting the sensing target object based on the first and second instances of the wireless communications signal.

Example embodiments can also provide a method of joint communication and sensing performed by a second communications node of a wireless communications network. The method comprises determining a predefined time window for a first communications node of the wireless communications network. The pre-defined time window is after reception of a first instance of a wireless communications signal by the first communications node. The predefined time window is for the first communications node to determine that a second instance of a wireless communications signal is received by the first communications node within the pre-defined time window. The second instance of the wireless communications signal is a reflection of the wireless communications signal from a sensing target object. Instead of, or in addition to, determining the predefined time window, the method comprises determining a predefined angular range for the first communications node. The pre-defined angular range is for the first communications node to determine that the second instance of the wireless communications signal was received by the first communications node after reception of the first instance of the wireless communications signal within the predefined angular range. The method comprises transmitting an indication of the predefined time window and/or the predefined angular range to the first communications node.

As will be explained with reference to the detailed description below, the determining that the second instance of the wireless communications signal has been received within a predefined time window after reception of the first instance of the wireless communications signal and/or received within a predefined angular reception range, can improve computing resource usage efficiency in the context of joint communication and sensing while maintaining a low risk of undesirable missed detections.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure.

FIG. 2 schematically represents some aspects of a new radio access technology (RAT) wireless telecommunications system which may be configured to operate in accordance with certain embodiments of the present disclosure.

FIG. 3 is a schematic block diagram of an example infrastructure equipment and communications device which may be configured to operate in accordance with certain embodiments of the present disclosure.

FIG. 4 schematically illustrates an example of joint communication and sensing;

FIG. 5 is a flow diagram illustrating a method of joint communication and sensing performed by a communications node in accordance with example embodiments;

FIG. 6 schematically illustrates an example of joint communication and sensing in accordance with example embodiments;

FIG. 7 schematically illustrates an example of joint communication and sensing in accordance with example embodiments;

FIG. 8 schematically illustrates an example of joint communication and sensing in accordance with example embodiments.

### DETAILED DESCRIPTION OF THE EMBODIMENTS

### Long Term Evolution Advanced Radio Access Technology (4G)

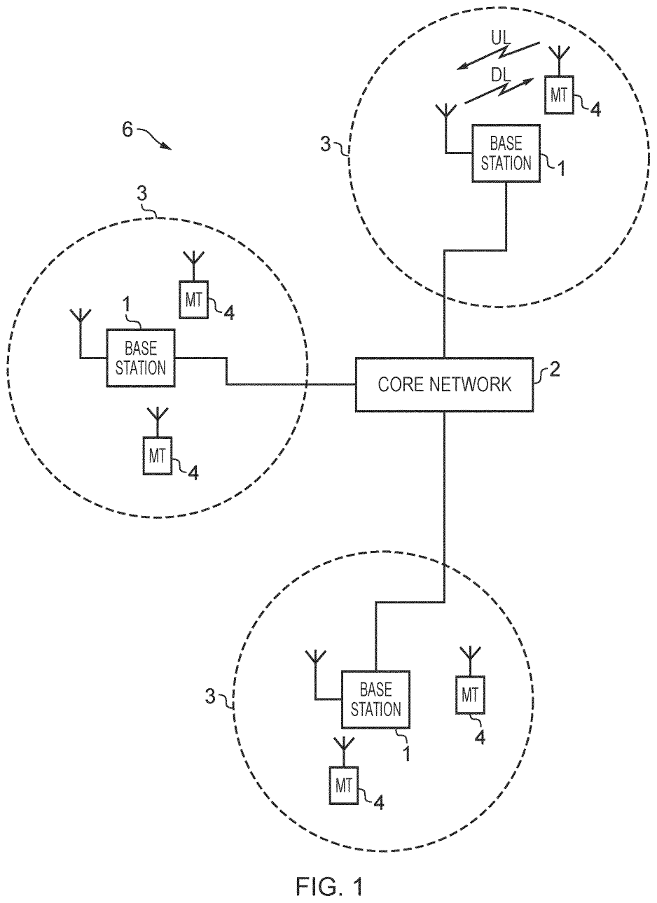

FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP (RTM) body, and also described in many books on the subject, for example, Holma H. and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4. Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices 4 within their respective coverage areas 3 via a radio downlink. Data is transmitted from communications devices 4 to the base stations 1 via a radio uplink. The core network 2 routes data to and from the communications devices 4 via the respective base stations 1 and provides functions such as authentication, mobility management, charging and so on. Terminal devices may also be referred to as mobile stations, user equipment (UE), user terminal, mobile radio, communications device, and so forth. Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

Systems incorporating NR technology are expected to support different services (or types of services), which may be characterised by different requirements for latency, data rate and/or reliability. For example, Enhanced Mobile Broadband (eMBB) services are characterised by high capacity with a requirement to support up to 20 GB/s. The requirements for Ultra Reliable and Low Latency Communications (URLLC) services are for one transmission of a 32 byte packet to be transmitted from the radio protocol layer 2/3 SDU ingress point to the radio protocol layer 2/3 SDU egress point of the radio interface within 1 ms with a reliability of 1-10⁻⁵ (99.999%) or higher (99.9999%) [2].

Massive Machine Type Communications (mMTC) is another example of a service which may be supported by NR-based communications networks. In addition, systems may be expected to support further enhancements related to Industrial Internet of Things (IloT) in order to support services with new requirements of high availability, high reliability, low latency, and in some cases, high-accuracy positioning.

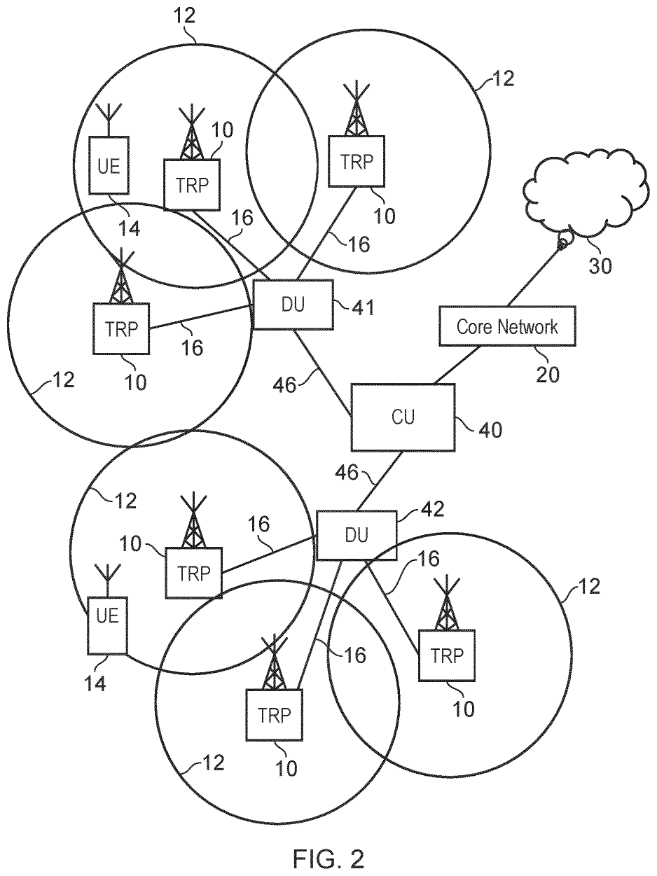

An example configuration of a wireless communications network which uses some of the terminology proposed for and used in NR and 5G is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 12 via one of the distributed units/TRPs 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus, certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a control unit/controlling node 40 and/or a TRP 10 of the kind shown in FIG. 2 which is adapted to provide functionality in accordance with the principles described herein.

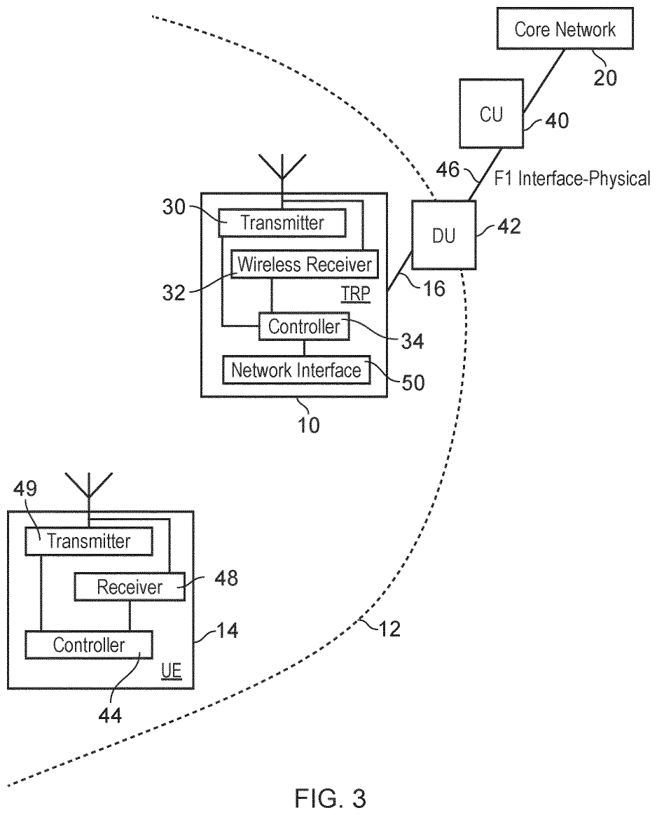

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 3, an example UE 14 is shown to include a corresponding transmitter 49, a receiver 48 and a controller 44 which is configured to control the transmitter 49 and the receiver 48 to transmit signals representing uplink data to the wireless communications network via the wireless access interface formed by the TRP 10 and to receive downlink data as signals transmitted by the transmitter 30 and received by the receiver 48 in accordance with the conventional operation.

The transmitters 30, 49 and the receivers 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controllers 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473, and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP10 to the DU 42 and the F1 interface 46 from the DU 42 to the CU 40.

### Joint Communication and Sensing

Recent areas of interest in this field relate to joint (or integrated) communication and sensing [3], particularly wireless sensing and the applications that this may have in future technology with respect to vehicles and vehicle-based technology systems.

Wireless sensing is the acquisition of information related to a remote object and its characteristics without any physical contact with the object itself. Such an object may be referred to as a “sensing target object”. Data relating to the perception of the object and its surroundings may be analysed by a communications device, and characteristics of the object may be determined from this analysis process. For example, a common form of wireless sensing is radar, which may use radio waves to determine at least the distance to, angle of, and/or instantaneous velocity of, a remote object without any physical contact between the object and a sensing device such as a radar gun. Other radio-frequency, RF, sensing techniques are available, in addition to non-RF sensing techniques such as time-of-flight cameras, accelerometers, gyroscopes, and Lidar.

Joint/Integrated communication and sensing includes at least two scenarios, which can be broadly divided into communication assisted sensing and sensing assisted communication. Communication assisted sensing may be thought of e.g. as a communication system, and the operation thereof, providing sensing services. Sensing assisted communication may be thought of, e.g. as when sensing information related to a communication channel or environment is used to improve a communication service of a communication system itself. For example, sensing information may be used to assist radio resource management, interference mitigation, beam management, mobility etc. of a communications system such as a 5G wireless communications network.

With regard to the first of these scenarios, communication assisted sensing, there are a number of services where this technology might be employed. One example of these include real-time monitoring of the environment of a communication system. That is to say, wireless signals may be used to reconstruct a local environment map, with the aim of further improving positioning accuracy and enabling environment related applications. Such environment related applications may include the creation and maintenance of a dynamic 3D map for driving assistance, pedestrian flow statistics, intrusion detection, etc. Another example may include the application of communication assisted sensing to autonomous vehicles or unmanned aerial vehicles, which, although different, have some common functional requirements and so have been amalgamated here for the sake of brevity. For example, both autonomous vehicles and UAVs may support Detect and Avoid, DAA, procedures to avoid obstacles and collisions. Furthermore, both may have capability for monitoring path information, such as traffic monitoring, selection of routes, complying with traffic regulations etc.

Another example of using communication assisted sensing would be the monitoring of air pollution. The quality of a received wireless signal displays different attenuation characteristics and coefficients as a function of air humidity, air particulate matter, PM, concentration, carrier frequency, etc. It is anticipated that this may be used for weather and air quality monitoring and detection. A final example related to communication assisted sensing is the application of this technology to indoor healthcare and intrusion detection. A number of medical and healthcare objectives may be achieved using this technology, such as estimation of respiration rate, estimation of breathing depth, apnoea detection, monitoring of vital signs of elders and infants, and indoor intrusion detection.

Sensing assisted communication also has a number of potential applications, and the sensing of wireless communication channels and the surrounding environment could further improve the performance of communication systems. Some examples of sensing assisted communications include narrowing a beam sweeping range and shortening a beam training time as a result of sensing a user equipment/communications device's location and channel environment. This may have benefits of reducing a time required to establish a connection between a communications device and a wireless communications network, and thus reduce both interference of signals on a wireless access interface and power consumption. Another application relates to prediction. Through sensing a communications device's location, velocity, motion trajectory and channel environment, either as a standalone procedure or as part of a beamforming process described above, overheads of communications related to beam measurement and the delay of beam tracking may be reduced. Furthermore, sensing of a communications device's properties and channel environment may allow improvements with respect to a channel estimation for communication between the communications device and the wireless access network.

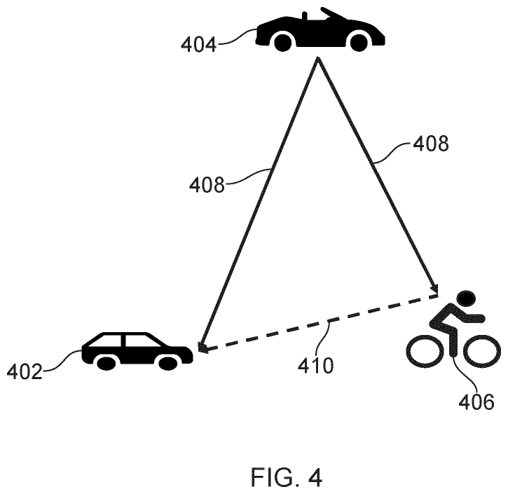

FIG. 4 schematically illustrates an example of joint communication and sensing. As shown in FIG. 4, a second communications node 404 transmits a wireless communications signal 408. The wireless communications signal 408 is for communicating information from the second communications node 404 to the first communications node 402. As shown in FIG. 4, the wireless communications signal 408 is received by the first communications node 402 directly from the second communications node 404. In other words, the first communications node 402 receives a first instance of the wireless communications signal 408 transmitted by the second wireless communications node 404. Furthermore, as shown in FIG. 4, the wireless communications signal 408 transmitted by the second communications node 404 also reflects off a sensing target object 406. The reflected wireless communications signal 410 is also received by the first communications node 402. In other words, the first communications node 402 receives a second instance of the wireless communications signal 408 transmitted by the second communications node 404. The reflection of the wireless communications signal 408 may follow substantially the same physical principles as radar signal reflection as will be known to one skilled in the art.

The first communications node 402 determines, based on a comparison of the first and second instances of the wireless communications signal 408, that the first and second instances of the wireless communications signal 408 are instances of the same wireless communications signal 408. For example, the first communications node 402 may perform cross-correlation on the first and second instances of the wireless communications signal 408 and identify a correlation peak based on the cross-correlation. If the correlation peak is above a predefined threshold level, then the first communications node 402 determines that the first and second instances of the wireless communications signal 408 are instances of the same wireless communications signal 408. Therefore, the first communications node 402 determines that it can use the first and second instances of the wireless communications signal 408 to detect the sensing target object 406. Aside from cross-correlation, other methods of comparing the first and second instances of the wireless communications signal 408 to determine that they are instances of the same wireless communications signal 408 will be known to one skilled in the art.

The term “communications node” is used herein to refer to an entity capable of wireless communications. For example, a communications node may be a communications device (such as a UE or relay UE) or infrastructure equipment of the wireless communications network (such as a gNB).

In the example shown in FIG. 4, the first communications node 402 is comprised in a vehicle and the second communications node 404 is comprised in another vehicle. The vehicles may be road, sea or aerial vehicles for example. The first and second communications nodes 402, 404 may be communications circuitry embedded in the respective vehicles or communications devices mounted in the respective vehicles. In the example shown in FIG. 4, the sensing target object 406 is a cyclist. In this example, the detection of the sensing target object 406 may comprise determining a moving speed, moving direction and/or position of the sensing target object 406 relative to the first communications node 402. For example, the moving speed, moving direction and/or position of the sensing target object 406 relative to the first communications node 402 by comparing a time of arrival of the first instance of the wireless communications signal 408 with a time of arrival of the second instance of the wireless communications signal 408. In some examples, the second communications node 404 may transmit assistance information to the first communications node 402 for the first communications node 402 to detect the sensing target object 406 based on the assistance information, the first instance of the wireless communications signal 408 and the second instance of the wireless communications signal 408. The assistance information may comprise one or more of a transmission time of the wireless communications signal 408 and an angle of departure of the wireless communications signal 408 from the second communications node 404. In some embodiments, the first communications node 402 determines a distance between the first communications node 402 and the second communications node 404 based on a time of arrival of the first instance of the wireless communications signal 408 at the first communications node 402 and the transmission time of the wireless communications signal 408 in the assistance information. In some embodiments, the distance between the first communications node 402 and the second communications node 404 is included in the assistance information. In some embodiments, the assistance information may be included in the wireless communications signal 408. In some embodiments, the assistance information is transmitted to the first communications node by via LIDAR or RADAR. In some embodiments, where the first communications node is comprised in a vehicle, the assistance information is provided to the first communications node by a sensor of the vehicle, such as a revolutions per minute (RPM) sensor.

Therefore, the first communications node 402 can determine whether or not there is a risk of collision with the sensing target object 406. In other words, the first communications node 402 can determine whether or not the sensing target object 406 is a potential collision hazard. For example, the first communications node 404 may determine that the sensing target object 406 is a potential collision hazard if it determines that the sensing target object 406 is below a predefined threshold distance from the first communications node 402. In response to detecting that the sensing target object 406 is a potential collision hazard, the first communications node 402 may be configured to take corrective action. For example, the first communications node 402 may be configured to cause a display a warning on a screen in the vehicle which warns the driver of the potential collision hazard. In another example, the first communications node 402 may be configured to communicate an indication of the potential collision hazard to braking circuitry in the vehicle which causes the vehicle to brake in response.

In another example, the first communications node may be configured to communicate an indication of the potential collision hazard to warning sound circuitry in the vehicle which causes the vehicle to emit a warning sound (which as a vehicle horn) to warn the sensing target object 406 of the imminent collision.

It has been explained above that the first communications node 402 compares the first and second instances of the wireless communications signal 408 (for example, by performing cross-correlation) for the purpose of determining that the first and second instances are instances of the same wireless communications signal 408. However, the present inventors have recognised that if, after receiving the wireless communications signal 408, the first communications node 402 performs cross-correlation (or otherwise compares the first and second instances of the wireless communications signal 408) on every received instance of the wireless communications signal 408 subsequent to the first instance wireless communications signal 408, computing resources in the first communications node 402 are inefficiently utilised. For example, in the case of complicated scenarios such as a downtown area in urban city, where there may be a huge number of potential hazards, the number of reflected signals is expected to be very high. Comparing each reflected signal received at the first communications node 402 with the first instance of the wireless communication signal 408 would require a large amount of computing resources. On the other hand, if cross-correlation (or otherwise comparing the first and second instances of the first and second instances of the wireless communications signal 408) is not performed on subsequent received instances of the wireless communications signal 408, then sensing target objects (such as potential hazards) may be missed.

There is therefore a need for communications nodes and methods for joint communications and sensing with improved computing resource usage efficiency.

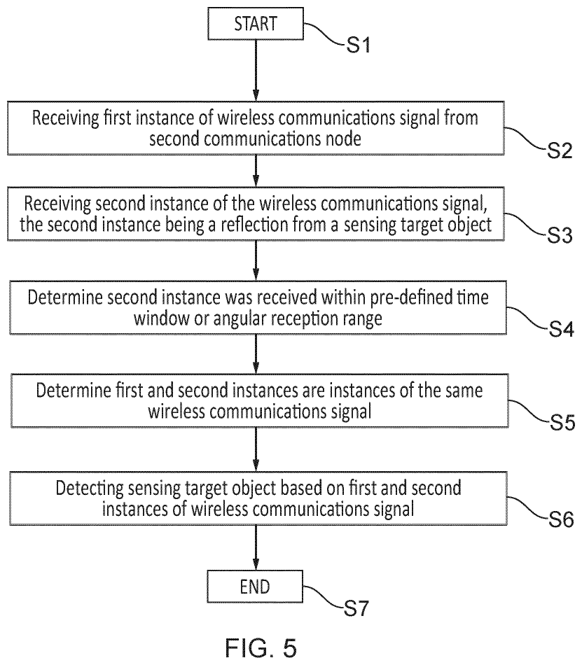

FIG. 5 illustrates a method of joint communication and sensing performed by a first communications node of a wireless communications network. The method begins in step S1.

After step S1, in step S2, the method comprises receiving a first instance of a wireless communications signal transmitted by a second communications node of the wireless communications network. For example, the wireless communications signal may be received by the first communications node directly from the second communications node. In some embodiments, the first instance of the wireless communications signal is received indirectly from the second communications node. For example, the first instance of the wireless communications signal may be a reflection or refraction of the wireless communications signal transmitted by the second communications node.

After step S2, in step S3, the method comprises receiving a second instance of the wireless communications signal transmitted by the second communications node. The second instance of the wireless communications signal is a reflection of the wireless communications signal transmitted by the second communications node from a sensing target object. For example, the wireless communications signal may reflect off the sensing target object and then proceed directly to the first communications node 402 to be received as the second instance of the wireless communications signal. In some examples, the second instance of the wireless communications signal may reflect off the sensing target object and also reflect off, or refract through, one or more other objects before reaching the first communications node. It will be understood that the second instance of the wireless communications signal is received by the first communications node after the first instance of the wireless communications signal. In some embodiments, the sensing target object may be a communications node.

After step S3, in step S4, the method comprises determining that the second instance of the wireless communications signal was received by the first communications node within a predefined time window after reception of the first instance of the wireless communications signal and/or determining that the second instance of the wireless communications signal was received by the first communications node after reception of the first instance of the wireless communication signal within a predefined angular reception range. In some embodiments, both a start point and an end point of the predefined time window are points in time after reception of the first instance of the wireless communications signal. In other embodiments, the start point is defined by the time at which the first instance of the wireless communications signal is received and the end point is a point in time after reception of the first instance of the wireless communications signal. In some embodiments, the method comprises determining that the second instance of the wireless communications signal was received by the first communications node within a predefined time window after reception of the first instance of the wireless communications signal. In some embodiments, the method comprises determining that the second instance of the wireless communications signal was received by the first communications node after reception of the first instance of the wireless communication signal within a predefined angular reception range. In some embodiments, the method comprises determining both that the second instance of the wireless communications signal was received by the first communications node within a predefined time window after reception of the first instance of the wireless communications signal and that the second instance of the wireless communications signal was received by the first communications node after reception of the first instance of the wireless communication signal within a predefined angular reception range.

The predefined time window and/or predefined angular reception range may be configured by the first communications node itself. Alternatively, the first communications node may receive an indication of the predefined time window and/or predefined angular reception range from the second communications node or a third communications node of the wireless communications network. In some embodiments, the first communications node configures the predefined time window itself but receives the indication of the predefined angular reception range from the second or third communications node. In some embodiments, the first communications node configures the predefined angular reception range itself but receives the indication of the predefined time window from the second or third communications node. In some embodiments, the first communications node comprises a first directional antenna for receiving the first instance of the wireless communications signal and a second directional antenna for receiving the second instance of the wireless communications signal. In such embodiments, the first communications node can determine that the second instance of the wireless communications signal was received within the predefined angular reception range because it was received by the second directional antenna.

After step S4, in step S5, the method comprises, in response, determining, based on a comparison between the first instance of the wireless communications signal and the second instance of the wireless communications signal, that the first and second instances of the wireless communications signal are instances of the same wireless communications signal. For example, performing cross-correlation on the first and second instances of the wireless communications signal, identifying a correlation peak based on the cross-correlation, and determining that an amplitude of the correlation peak is above a predefined threshold level. As will be understood by one skilled in the art, cross-correlation is a measure of a similarity of two series as a function of displacement of one of the series relative to the other. This is also known as a sliding dot product or sliding inner-product. Cross-correlation is widely used in telecommunications (for example, synchronisation signal detection) and the principles of cross-correlation are well understood by one skilled in the art.

After step S5, in step S6, the method comprises detecting the sensing target object based on the first and second instances of the wireless communications signal. For example, in embodiments where the first communications node and the sensing target object are in motion relative to each other, the first communications node may determine a moving speed, moving direction and/or position of the sensing target object relative to the first communications node based on the first and second instances of the wireless communications signal. In some embodiments, the first communications signal receives one or more other instances of the wireless communications signal which have respectively reflected off one or more other sensing target objects. In such embodiments, the first communications node repeats steps S4 to S6 based on the one or more other instances of the wireless communications signal to detect the respective one or more other sensing target objects. In particular, each of the one or more other instances of the wireless communications signal are determined to be instances of the same wireless communications signal as the first instance by comparing each of the one or more other instances with the first instance in turn. Furthermore, the one or more other sensing target objects are detected based on the first instance of the wireless communications signal and each of the one or more other instances of the wireless communications signal in turn. In some embodiments, the first communications node may receive a second wireless communications signal from the second communications node and repeat steps S2 to S6 based on the second wireless communications signal.

The method ends in step S7.

Although FIG. 5 was described in a specific sequence of steps, the skilled person will understand that these steps can be interchanged or combined in any logical manner.

The method described with reference to FIG. 5 can improve computing resource usage efficiency in the context of joint communication and sensing. In particular, the method described in FIG. 5 recognises that by determining that the second instance of the wireless communications signal has been received within a predefined time window after reception of the first instance of the wireless communications signal and/or received within a predefined angular reception range, computing efficiency can be increased while maintaining a low risk of undesirable missed detections (such as missed detections of potential hazards). This is because only second instances of the wireless communications signal which likely to lead to detection of a sensing target object of interest to the first communications node (i.e. those which fall within the predefined time window and/or angular reception range) are processed for comparison with the first instance of the wireless communications signal and then processed for sensing target object detection. For example, in the downtown urban area example mentioned above, although there may be a large number of reflected signals from sensing target objects, only a subset of the sensing target objects are of interest to the first communications node 402 because, for example, only the subset of sensing target objects are potential sources of imminent danger the first communications node 402. The above method can filter out signals from sensing target objects which are not of interest to the first communications node 402 before they are processed for comparison with the first instance of the wireless communication signal, thereby increasing communications efficiency. In other examples, the sensing target object of interest may be an object in a target region to be reconstructed by the first communications node as a real time 3D map, or reconstructed by the first communications node in augmented reality (AR) or virtual reality (VR). Since only wireless communications signals reflected from sensing target objects in the region of interest are processed for comparison with the first instance of the wireless communications signal and then processed for sensing target object detection, then communications efficiency is increased. In some embodiments, computing efficiency is increased further by requiring that the second instance of the wireless communications signal is received within the predefined time window and within the predefined angular range. In other words, step S4 comprises determining both that the second instance of the wireless communications signal was received by the first communications node within a predefined time window after reception of the first instance of the wireless communications signal and that the second instance of the wireless communications signal was received by the first communications node after reception of the first instance of the wireless communication signal within a predefined angular reception range.

In some embodiments, the predefined time window may be based on a predefined sensing distance range within which the sensing target object is a potential collision hazard for the first communications node. In such embodiments, the first communications node may only be interested in detecting a sensing target object which is within the predefined sensing distance range. Computation efficiency is increased because the first communications node does not need to process instances of the wireless communications signal which are received outside the predefined time window for comparison with the first instance of the wireless communications signal and therefore does not need to perform processing for sensing target object detection based on those signals. Also, there is no risk of undesirably missed detections because the first communications node is only interested in detecting sensing target objects in the sensing distance range.

In some embodiments, where the first communications node is comprised in a vehicle, the predefined angular reception range is limited to wireless communications signals received from blind spots of the vehicle. Computation efficiency is increased because the first communications node does not need to process instances of the wireless communications signal which are received outside the predefined angular reception range for comparison with the first instance of the wireless communications signal and therefore does not need to perform processing for sensing target object detection based on those signals. Also, there is no risk of undesirably missed detections because a user of the vehicle can visibly detect sensing target objects which are not in the blind spots of the vehicle.

In some embodiments, computing efficiency can be increased further by requiring determining that the second instance of the wireless communications signal is received both within the time window based on the sensing distance range and within the angular reception range limited to wireless communications signals received from blind spots of the vehicle.

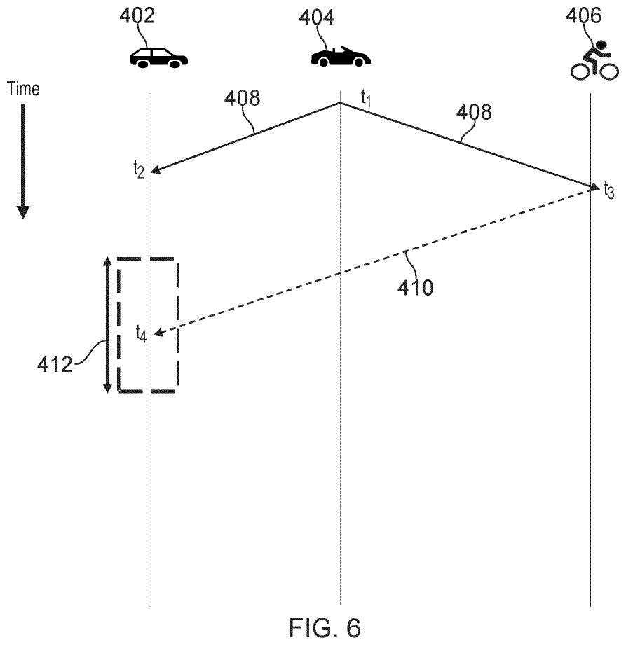

FIG. 6 schematically illustrates an example of joint communication and sensing in accordance with example embodiments. As shown in FIG. 6, the second communications node 404 transmits the wireless communications signal 408 at time t₁. At time t₂, the first instance of the wireless communications signal 408 is received at the first communications node 402. At time t₃, the wireless communications signal 408 reflects off the sensing target object 406. Although FIG. 6 illustrates an embodiment in which the first instance of the wireless communications signal 408 is received at the first communications node 402 before the wireless communications 408 reflects off the sensing target object 406, it will be appreciated that, in other embodiments, the first instance of the wireless communications signal 408 may be received at the first communications node 402 after, or at the same time as, the wireless communications signal 408 reflects off the sensing target object 406. As shown in FIG. 6, the reflected wireless communications signal 410 is received at the first communications node at t₄. In other words, the first communications node 402 receives a second instance of the wireless communications signal 408 at t₄. As shown in FIG. 6, the first communications device 402 is configured with a predefined time window 412. As shown in FIG. 6, a lower limit of the predefined time window 412 is after the time t₂ at which the first instance of the wireless communications signal 408 is received at the first communications node 402 so that the first communications node 402 can distinguish between the first and second instances of the wireless communications signal 408.

In some embodiments, the first communications device 402 configures the pre-defined time window. In some embodiments, the second communications node 404, or a third communications node (not shown), transmits an indication of the pre-defined time window 412 to the first communications node 402. In some embodiments, the pre-defined time window 412 is fixed in predefined specifications and therefore preconfigured in the first communications node 402.

In the example shown in FIG. 6, the time t₄ at which the second instance of the wireless communications signal 408 is received by the first communications node 402 is within the predefined window 412. Therefore, in response to determining that the second instance of the wireless communications signal 408 is received by the first communications node 402 is within the predefined window 412, the first communications node 402 compares the first instance of the wireless communications signal 408 and the second instance of the wireless communications signal 408 to determine whether the first and second instances are instances of the same wireless communications signal 408 (for example, by performing cross-correlation as explained above). If the first communications node 402 determines that the first and second instances are instances of the same wireless communications signal 408, then the first communications node 402 proceeds to detect the sensing target object 406 based on the first and second instances of the wireless communications signal 408.

In the example described with reference to FIG. 6, if the time t₄ at which the second instance of the wireless communications signal 408 is received by the first communications node 402 was not within the predefined window 412, then the first communications node 402 would not compare the second instance of the wireless communications signal 408 with the first instance of the wireless communications signal 408 and would not therefore detect the sensing target object 406 based on the first and second instances of the wireless communications signal 408. Accordingly computing resource efficiency is improved by only utilising the second instance of the wireless communications signal 408 for detecting the sensing target object 406 if it is received within the predefined time window 412.

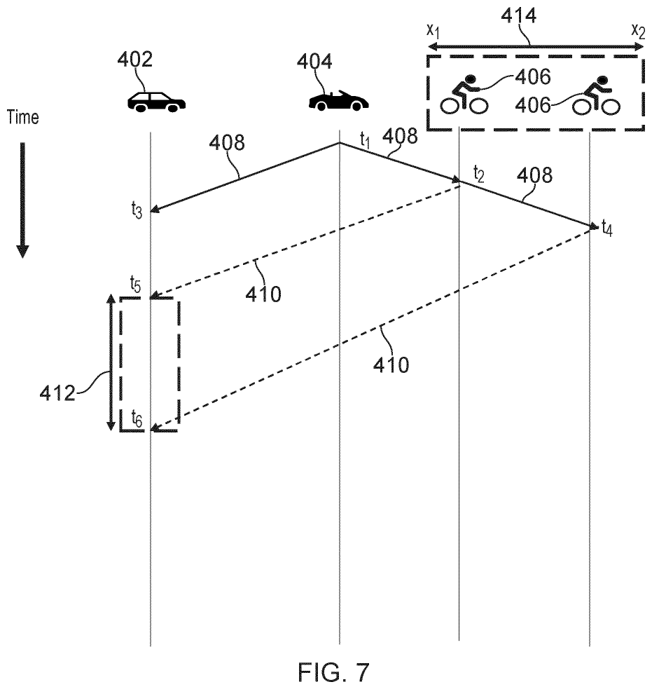

FIG. 7 illustrates another example of joint communication and sensing in accordance with example embodiments. In the example shown in FIG. 7, the predefined time window 412 is based on a predefined sensing distance range 414 within which the sensing target object 406 is of interest. For example, the predefined sensing distance range 414 may be a distance range within which the sensing target object 406 is a potential collision hazard for the first communications node 402. As shown in FIG. 7, an upper limit t₆ of the predefined time window 412 is based on a distance x₂ from the first communications node 402 beyond which the sensing target object 406 is not of interest, For example, the distance x₂ from the first communications node 402 may be a distance beyond which the sensing target object 406 is not a potential collision hazard for the first communications node 402. As shown in FIG. 7, a lower limit t₅ of the predefined time window 412 is based on a distance x₁ from the first communications node 402 below which sensing target object 406 is not of interest. For example, the distance x₁ from the first communications node 402 may be a distance below which the sensing target object 406 is so close to the sensing target object 406 that collision is unavoidable.

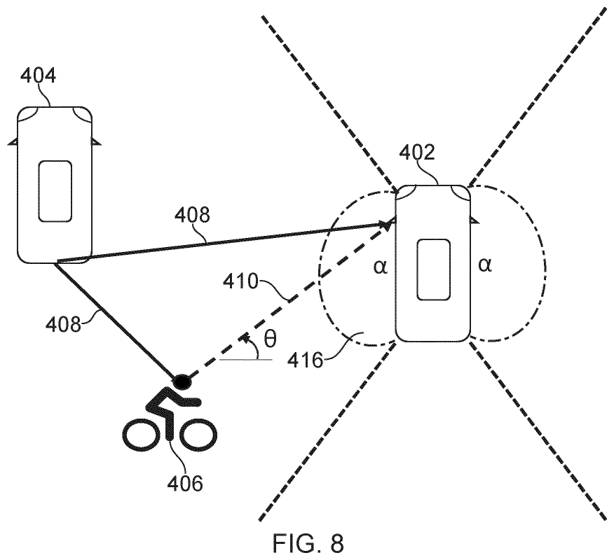

FIG. 8 illustrates another example of joint communication and sensing in accordance with example embodiments. In particular, FIG. 8 illustrates an example embodiment in which the first communications node 402 determines that the second instance of the wireless communications signal 408 was received by the first communications node 402 after reception of the first instance of the wireless communication signal 408 within a predefined angular reception range. As shown in FIG. 8, the predefined angular reception range is limited to signals received from blind spots 416 of the vehicle in which the first communications node 402 is comprised.

As shown in FIG. 8, one blind spot of the vehicle is defined by the angular reception range expressed in Equation 1:

$$- \frac{α}{2} \leq θ \leq \frac{α}{2} \qquad Equation 1$$

As shown in FIG. 8, the other blind spot 416 of the vehicle is defined by the angular reception range expressed in Equation 2:

$$180 ° - \frac{α}{2} \leq θ \leq 180 ° + \frac{α}{2} \qquad Equation 2$$

In the example shown in FIG. 8, the first communications node 402 determines that the reflected wireless communications signal 410 is within the predefined angular range expressed in equation 1 or 2. In other words, the first communications node 402 determines that the second instance of the wireless communications signal 408 is within the predefined angular range expressed in equation 1 or 2.

Therefore, in response to determining that the second instance of the wireless communications signal 408 received by the first communications node 402 is within the predefined angular reception range, the first communications node 402 compares the first instance of the wireless communications signal 408 and the second instance of the wireless communications signal 408 to determine whether the first and second instances are instances of the same wireless communications signal 408 (for example, by performing cross-correlation as explained above). If the first communications node 402 determines that the first and second instances are instances of the same wireless communications signal 408, then the first communications node 402 proceeds to detect the sensing target object 406 based on the first and second instances of the wireless communications signal 408.

In the example described with reference to FIG. 8, if the first communications node 402 determines that the second instance of the wireless communications signal 408 is received by the first communications node 402 outside the predefined angular reception range, then the first communications node 402 does not compare the second instance of the wireless communications signal 408 with the first instance of the wireless communications signal 408 and does not therefore detect the sensing target object 406 based on the first and second instances of the wireless communications signal 408. Accordingly computing resource efficiency is improved by only utilising the second instance of the wireless communications signal for detecting the sensing target object 406 if it is received within the angular reception range.

As mentioned above, in some embodiments, the first communications node 402 receives an indication of the predefined time window and/or the predefined angular reception range from the second communications node or a third communications node of the wireless communications network. In some embodiments, the first communications node 402 is a communications device (such as a UE) and the communications node from which the indication is received (i.e. the second communications node 404 or the third communications node) is infrastructure equipment (such as a gNB or roadside communications node) of the wireless communications network. In such embodiments, the infrastructure equipment from which indication is received determines the predefined time window and/or angular reception range for the first communications node 402. This can result in a time window and/or angular reception range with even higher computing efficiency because the infrastructure equipment has an overview of the wireless communications network and can therefore make a more balanced decision on the time window and/or angular reception ranges taking into account various factors such as the positions of the first and second communications nodes 402, 404 and the computational limitations of the first communications node 402. The infrastructure equipment may determine different time windows and/or angular reception ranges for different communications devices, or groups of communications devices, under the control of the infrastructure equipment.

In one example, a group of communications devices may be located in a cell controlled by infrastructure equipment of the wireless communications network. In this example, one of the communications devices transmits the wireless communications signal to another of the communications devices. In this example, the start time of the predefined time window is the time at which the communications device receives a first instance of the wireless communications signal. The infrastructure equipment is aware that the communications devices are located within about 5 metres of each other and the infrastructure equipment therefore configures a predefined time window for the group of communications devices with a duration corresponding to the time taken for the wireless communications signal to travel a distance of about 5 metres. Also in the cell controlled by the infrastructure equipment, there may be a communications node comprised in a vehicle which has a braking distance of 100 metres. A wireless communications signal may be transmitted from one of the communications devices to the communications node in the vehicle and the start time of the predefined time window for the communications node in the vehicle is the time at which a first instance of the wireless communications is received by the communications node comprised in the vehicle.

Therefore, the infrastructure equipment configures a predefined time window for the communications node in the vehicle with a duration corresponding to the time taken for the wireless communications signal to travel about 100 metres.

In another example, a communications node comprised in a lorry and another communications node comprises in a car may be located in a cell controlled by the infrastructure equipment. In this example, the infrastructure equipment is aware that the lorry and car have different blind spots and therefore configures the predefined angular reception range differently for the communications node comprised in the lorry and for the communications node comprised in the car.

In some embodiments, the indication of the predefined time window and/or the predefined angular reception range is transmitted in a signal dedicated for the first communications node. For example, the signal may be a UE dedicated signal.

In some embodiments, the indication of the predefined time window and/or the predefined angular reception range is transmitted in a signal dedicated for a group of communications nodes including the first communications node 402. For example, the signal may be a UE group-specific signal.

In some embodiments, the indication of the predefined time window and/or the predefined angular reception range is transmitted in a broadcast signal in a cell provided by the infrastructure equipment. For example, the infrastructure equipment may broadcast the indication to all communications devices located within a cell provided by the infrastructure equipment.

In some embodiments, first communications node 402 is a communications device and the communications node from which the indication of the predefined time window and/or the predefined angular reception range is received is another communications device. For example, the indication may be transmitted as a device-to-device (D2D) communications signal. The D2D signal may be transmitted via a PC-5 wireless access interface.

The following numbered paragraphs provide further example aspects and features of the present technique:

Paragraph 1. A method of joint communication and sensing performed by a first communications node of a wireless communications network, the method comprising
receiving a first instance of a wireless communications signal transmitted by a second communications node of the wireless communications network,
receiving a second instance of the wireless communications signal transmitted by the second communications node, the second instance of the wireless communications signal being a reflection of the wireless communications signal transmitted by the second communications node from a sensing target object,
determining that the second instance of the wireless communications signal was received by the first communications node within a predefined time window after reception of the first instance of the wireless communications signal and/or determining that the second instance of the wireless communications signal was received by the first communications node after reception of the first instance of the wireless communication signal within a predefined angular reception range, and in response,
determining, based on a comparison between the first instance of the wireless communications signal and the second instance of the wireless communications signal, that the first and second instances of the wireless communications signal are instances of the same wireless communications signal, and
detecting the sensing target object based on the first and second instances of the wireless communications signal.

Paragraph 2. A method according to paragraph 1, wherein the method comprises
configuring the predefined time window and/or the predefined angular reception range.

Paragraph 3. A method according to paragraph 1, wherein the method comprises
receiving an indication of the predefined time window and/or the predefined angular range from the second communications node or a third communications node of the wireless communications network.

Paragraph 4. A method according to paragraph 3, wherein the first communications node is a communications device and the communications node from which the indication is received is infrastructure equipment of the wireless communications network.

Paragraph 5. A method according to paragraph 4, wherein the indication is transmitted in a signal dedicated for the first communications node.

Paragraph 6. A method according to paragraph 4, wherein the indication is transmitted in a signal dedicated for a group of communications nodes including the first communications node.

Paragraph 7. A method according to paragraph 4, wherein the indication is transmitted in a broadcast signal in a cell provided by the infrastructure equipment.

Paragraph 8. A method according to paragraph 3, wherein the first communications node is a communications device and the communications node from which the indication is received is another communications device.

Paragraph 9. A method according to any of paragraphs 1 to 8, wherein the determining that the first and second instances are instances of the same wireless communications signal comprises
performing cross-correlation on the first and second instances of the wireless communications signal,
identifying a correlation peak based on the cross-correlation, and
determining that an amplitude of the correlation peak is above a predefined threshold level.

Paragraph 10. A method according to any of paragraphs 1 to 9, wherein at least one of the communications node and the sensing target object are in motion.

Paragraph 11. A method according to paragraph 10, wherein the predefined time window is based on a predefined sensing distance range within which the sensing target object is a potential collision hazard for the first communications node.

Paragraph 12. A method according to paragraph 11, wherein an upper limit of the predefined time window is based on a distance from the first communications node beyond which the sensing target object is not a potential collision hazard for the first communications node.

Paragraph 13. A method according to paragraph 11 or paragraph 12, wherein a lower limit of the predefined time window is based on a distance from the first communications node below which sensing target object is too close to the first communications node for the first communications node to detect the sensing target object before collision with the first communication node.

Paragraph 14. A method according to any of paragraphs 10 to 13, wherein the first communications node is comprised in a vehicle, and the predefined angular reception range is limited to signals received from blind spots of the vehicle.

Paragraph 15. A method according to any of paragraphs 10 to 14, wherein the detecting the sensing target object based on the first and second instances of the wireless communications signal comprises
determining a moving speed, moving direction and/or position of the sensing target object relative to the first communications node based on the first and second instances of the wireless communications signal.

Paragraph 16. A method according to any of paragraphs 1 to 15, wherein the receiving the first instance of the wireless communications signal transmitted by the second communications node comprises
receiving the first instance of the wireless communications signal using a first directional receive antenna of the first communications node, and
the receiving the second instance of the wireless communications signal transmitted by the second communications node comprises
receiving the second instance of the wireless communications signal using a second directional receive antenna of the first communications node, and
the determining that the second instance of the wireless communications signal was received by the first communications node within the predefined angular reception range comprises
determining that the second instance of the wireless communications signal was received by the second directional receive antenna of the first communications node.

Paragraph 17. A method of joint communication and sensing performed by a second communications node of a wireless communications network, the method comprising
determining a predefined time window for a first communications node of the wireless communications network, the pre-defined time window being after reception of a first instance of a wireless communications signal by the first communications node and being for the first communications node to determine that a second instance of a wireless communications signal is received by the first communications node within the pre-defined time window, the second instance of the wireless communications signal being a reflection of the wireless communications signal from a sensing target object, and/or
determining a predefined angular reception range for the first communications node, the predefined angular range being for the first communications node to determine that the second instance of the wireless communications signal was received by the first communications node after reception of the first instance of the wireless communications signal within the predefined angular range, and
transmitting an indication of the predefined time window and/or the predefined angular range to the first communications node.

Paragraph 18. A method according to paragraph 17, wherein the wireless communications signal is transmitted by the second communications node.

Paragraph 19. A method according to paragraph 17 or 18, wherein the first communications node is a communications device and the second communications node is infrastructure equipment of the wireless communications network.

Paragraph 20. A method according to paragraph 19, wherein the indication is transmitted in a signal dedicated for the first communications node.

Paragraph 21. A method according to paragraph 19, wherein the indication is transmitted in a signal dedicated for a group of communications nodes including the first communications node.

Paragraph 22. A method according to paragraph 19, wherein the indication is transmitted in a broadcast signal in a cell provided by the infrastructure equipment.

Paragraph 23. A method according to paragraph 17 or 18, wherein the first communications node is a communications device and the second communications node is another communications device.

Paragraph 24. A first communications node for joint communication and sensing in a wireless communications network, the first communications node comprising
a transmitter configured to transmit signals,
a receiver configured to receive signals, and
a controller configured in combination with the transmitter and the receiver to
receive a first instance of a wireless communications signal transmitted by a second communications node of the wireless communications network,
receive a second instance of the wireless communications signal transmitted by the second communications node, the second instance of the wireless communications signal being a reflection of the wireless communications signal transmitted by the second communications node from a sensing target object,
determine that the second instance of the wireless communications signal was received by the first communications node within a predefined time window after reception of the first instance of the wireless communications signal and/or determining that the second instance of the wireless communications signal was received by the first communications node after reception of the first instance of the wireless communication signal within a predefined angular reception range, and in response,
determine, based on a comparison between the first instance of the wireless communications signal and the second instance of the wireless communications signal, that the first and second instances of the wireless communications signal are instances of the same wireless communications signal, and
detect the sensing target object based on the first and second instances of the wireless communications signal.

Paragraph 25. A first communications node according to paragraph 24, wherein the controller is configured in combination with the transmitter and the receiver to configure the predefined time window and/or the predefined angular reception range.

Paragraph 26. A first communications node according to paragraph 24, wherein the controller is configured in combination with the transmitter and the receiver to
receive an indication of the predefined time window and/or the predefined angular range from the second communications node or a third communications node of the wireless communications network.

Paragraph 27. A first communications node according to paragraph 26, wherein the first communications node is a communications device and the communications node from which the indication is received is infrastructure equipment of the wireless communications network.

Paragraph 28. A first communications node according to paragraph 27, wherein the controller is configured in combination with the transmitter and the receiver to
receive the indication in a signal dedicated for the first communications node.

Paragraph 29. A first communications node according to paragraph 27, wherein the controller is configured in combination with the transmitter and the receiver to receive the indication in a signal dedicated for a group of communications nodes including the first communications node.

Paragraph 30. A first communications node according to paragraph 27, wherein the controller is configured in combination with the transmitter and the receiver to receive the indication in a broadcast signal in a cell provided by the infrastructure equipment.

Paragraph 31. A first communications node according to paragraph 26, wherein the first communications node is a communications device and the communications node from which the indication is received is another communications device.

Paragraph 32. A first communications node according to any of paragraphs 24 to 31, wherein the controller is configured in combination with the transmitter and the receiver to
perform cross-correlation on the first and second instances of the wireless communications signal,
identify a correlation peak based on the cross-correlation, and
determine that an amplitude of the correlation peak is above a predefined threshold level.

Paragraph 33. A first communications node according to any of paragraphs 24 to 32, wherein at least one of the communications node and the sensing target object are in motion.

Paragraph 34. A first communications node according to paragraph 33, wherein the predefined time window is based on a predefined sensing distance range within which the sensing target object is a potential collision hazard for the first communications node.

Paragraph 35. A first communications node according to paragraph 34, wherein an upper limit of the predefined time window is based on a distance from the first communications node beyond which the sensing target object is not a potential collision hazard for the first communications node.

Paragraph 36. A first communications node according to paragraph 34 or paragraph 35, wherein a lower limit of the predefined time window is based on a distance from the first communications node below which sensing target object is too close to the first communications node for the first communications node to detect the sensing target object before collision with the first communication node.

Paragraph 37. A first communications node according to any of paragraphs 33 to 37, wherein the first communications node is comprised in a vehicle, and the predefined angular reception range is limited to signals received from blind spots of the vehicle.

Paragraph 38. A first communications node according to any of paragraphs 33 to 37, wherein the controller is configured in combination with the transmitter and the receiver to determine a moving speed, moving direction and/or position of the sensing target object relative to the first communications node based on the first and second instances of the wireless communications signal.

Paragraph 39. A first communications node according to any of paragraphs 24 to 38, wherein the controller is configured in combination with the transmitter and the receiver to
receive the first instance of the wireless communications signal using a first directional receive antenna of the first communications node,
receive the second instance of the wireless communications signal using a second directional receive antenna of the first communications node, and
determine that the second instance of the wireless communications signal was received by the second directional receive antenna of the first communications node.

Paragraph 40. A second communications node for joint communication and sensing in a wireless communications network, the second communications node comprising
a transmitter configured to transmit signals,
a receiver configured to receive signals, and
a controller configured in combination with the transmitter and the receiver to
determine a predefined time window for a first communications node of the wireless communications network, the pre-defined time window being after reception of a first instance of a wireless communications signal by the first communications node and being for the first communications node to determine that a second instance of a wireless communications signal is received by the first communications node within the pre-defined time window, the second instance of the wireless communications signal being a reflection of the wireless communications signal from a sensing target object, and/or
determine a predefined angular reception range for the first communications node, the predefined angular range being for the first communications node to determine that the second instance of the wireless communications signal was received by the first communications node after reception of the first instance of the wireless communications signal within the predefined angular range, and
transmit an indication of the predefined time window and/or the predefined angular range to the first communications node.

Paragraph 41. A second communications node according to paragraph 40, wherein the controller is configured in combination with the transmitter and the receiver to
transmit the wireless communications signal.

Paragraph 42. A second communications node according to paragraph 40 or 41, wherein the first communications node is a communications device and the second communications node is infrastructure equipment of the wireless communications network.

Paragraph 43. A second communications node according to paragraph 42, wherein the controller is configured in combination with the transmitter and the receiver to
transmit the indication in a signal dedicated for the first communications node.

Paragraph 44. A second communications node according to paragraph 42, wherein the controller is configured in combination with the transmitter and the receiver to
transmit the indication in a signal dedicated for a group of communications nodes including the first communications node.

Paragraph 45. A second communications node according to paragraph 42, wherein the controller is configured in combination with the transmitter and the receiver to
transmit the indication in a broadcast signal in a cell provided by the infrastructure equipment.

Paragraph 46. A second communications node according to paragraph 40 or 41, wherein the first communications node is a communications device and the second communications node is another communications device.

Paragraph 47. Circuitry for a first communications node for joint communication and sensing in a wireless communications network, the circuitry comprising
transmitter circuitry configured to transmit signals,
receiver circuitry configured to receive signals, and
controller circuitry configured in combination with the transmitter circuitry and the receiver circuitry to
receive a first instance of a wireless communications signal transmitted by a second communications node of the wireless communications network,
receive a second instance of the wireless communications signal transmitted by the second communications node, the second instance of the wireless communications signal being a reflection of the wireless communications signal transmitted by the second communications node from a sensing target object,
determine that the second instance of the wireless communications signal was received by the first communications node within a predefined time window after reception of the first instance of the wireless communications signal and/or determining that the second instance of the wireless communications signal was received by the first communications node after reception of the first instance of the wireless communication signal within a predefined angular reception range, and in response,
determine, based on a comparison between the first instance of the wireless communications signal and the second instance of the wireless communications signal, that the first and second instances of the wireless communications signal are instances of the same wireless communications signal, and
detect the sensing target object based on the first and second instances of the wireless communications signal.

Paragraph 48. Circuitry for a second communications node for joint communication and sensing in a wireless communications network, the circuitry comprising
transmitter circuitry configured to transmit signals,
receiver circuitry configured to receive signals, and
controller circuitry configured in combination with the transmitter and the receiver to
determine a predefined time window for a first communications node of the wireless communications network, the pre-defined time window being after reception of a first instance of a wireless communications signal by the first communications node and being for the first communications node to determine that a second instance of a wireless communications signal is received by the first communications node within the pre-defined time window, the second instance of the wireless communications signal being a reflection of the wireless communications signal from a sensing target object, and/or
determine a predefined angular reception range for the first communications node, the predefined angular range being for the first communications node to determine that the second instance of the wireless communications signal was received by the first communications node after reception of the first instance of the wireless communications signal within the predefined angular range, and
transmit an indication of the predefined time window and/or the predefined angular range to the first communications node.

Paragraph 49. A wireless communications network comprising a first communications node according to paragraph 24 and a second communications node according to paragraph 40.

Paragraph 50. A computer program comprising instructions which, when loaded onto a computer, cause the computer to perform a method according to any of paragraphs 1 to 23.

Paragraph 51. A non-transitory computer-readable storage medium storing a computer program according to paragraph 50.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] Holma H. and Toskala A, “LTE for UMTS OFDMA and SC-FDMA based radio access”, John Wiley and Sons, 2009.
[2] TR 38.913, “Study on Scenarios and Requirements for Next Generation Access Technologies (Release 14)”, 3rd Generation Partnership Project, v14.3.0, August 2017.
[3] S1-220191, “Study on Integrated Sensing and Communication”, 3^{rd} Generation Partnership Project, February 2022
[4] S1-221091, “Coordinated Sensing Operations”, 3^{rd} Generation Partnership Project, May 2022

1. A method of joint communication and sensing performed by a first communications node of a wireless communications network, the method comprising
receiving a first instance of a wireless communications signal transmitted by a second communications node of the wireless communications network,
receiving a second instance of the wireless communications signal transmitted by the second communications node, the second instance of the wireless communications signal being a reflection of the wireless communications signal transmitted by the second communications node from a sensing target object,
determining that the second instance of the wireless communications signal was received by the first communications node within a predefined time window after reception of the first instance of the wireless communications signal and/or determining that the second instance of the wireless communications signal was received by the first communications node after reception of the first instance of the wireless communication signal within a predefined angular reception range, and in response,
determining, based on a comparison between the first instance of the wireless communications signal and the second instance of the wireless communications signal, that the first and second instances of the wireless communications signal are instances of the same wireless communications signal, and
detecting the sensing target object based on the first and second instances of the wireless communications signal.

2. A method according to claim 1, wherein the method comprises configuring the predefined time window and/or the predefined angular reception range.

3. A method according to claim 1, wherein the method comprises
receiving an indication of the predefined time window and/or the predefined angular range from the second communications node or a third communications node of the wireless communications network.

4. A method according to claim 3, wherein the first communications node is a communications device and the communications node from which the indication is received is infrastructure equipment of the wireless communications network.

5. A method according to claim 4, wherein the indication is transmitted in a signal dedicated for the first communications node.

6. A method according to claim 4, wherein the indication is transmitted in a signal dedicated for a group of communications nodes including the first communications node.

7. A method according to claim 4, wherein the indication is transmitted in a broadcast signal in a cell provided by the infrastructure equipment.

8. A method according to claim 3, wherein the first communications node is a communications device and the communications node from which the indication is received is another communications device.

9. A method according to claim 1, wherein the determining that the first and second instances are instances of the same wireless communications signal comprises
performing cross-correlation on the first and second instances of the wireless communications signal,
identifying a correlation peak based on the cross-correlation, and
determining that an amplitude of the correlation peak is above a predefined threshold level.

10. A method according to claim 1, wherein at least one of the communications node and the sensing target object are in motion.

11. A method according to claim 10, wherein the predefined time window is based on a predefined sensing distance range within which the sensing target object is a potential collision hazard for the first communications node.

12. A method according to claim 11, wherein an upper limit of the predefined time window is based on a distance from the first communications node beyond which the sensing target object is not a potential collision hazard for the first communications node.

13. A method according to claim 11, wherein a lower limit of the predefined time window is based on a distance from the first communications node below which sensing target object is too close to the first communications node for the first communications node to detect the sensing target object before collision with the first communication node.

14. A method according to claim 10, wherein the first communications node is comprised in a vehicle, and the predefined angular reception range is limited to signals received from blind spots of the vehicle.

15. A method according to claim 10, wherein the detecting the sensing target object based on the first and second instances of the wireless communications signal comprises determining a moving speed, moving direction and/or position of the sensing target object relative to the first communications node based on the first and second instances of the wireless communications signal.

16. A method according to claim 1, wherein the receiving the first instance of the wireless communications signal transmitted by the second communications node comprises
receiving the first instance of the wireless communications signal using a first directional receive antenna of the first communications node, and
the receiving the second instance of the wireless communications signal transmitted by the second communications node comprises
receiving the second instance of the wireless communications signal using a second directional receive antenna of the first communications node, and
the determining that the second instance of the wireless communications signal was received by the first communications node within the predefined angular reception range comprises
determining that the second instance of the wireless communications signal was received by the second directional receive antenna of the first communications node.

17.-46. (canceled)

47. Circuitry for a first communications node for joint communication and sensing in a wireless communications network, the circuitry comprising
transmitter circuitry configured to transmit signals,
receiver circuitry configured to receive signals, and
controller circuitry configured in combination with the transmitter circuitry and the receiver circuitry to
receive a first instance of a wireless communications signal transmitted by a second communications node of the wireless communications network,
receive a second instance of the wireless communications signal transmitted by the second communications node, the second instance of the wireless communications signal being a reflection of the wireless communications signal transmitted by the second communications node from a sensing target object,
determine that the second instance of the wireless communications signal was received by the first communications node within a predefined time window after reception of the first instance of the wireless communications signal and/or determining that the second instance of the wireless communications signal was received by the first communications node after reception of the first instance of the wireless communication signal within a predefined angular reception range, and in response,
determine, based on a comparison between the first instance of the wireless communications signal and the second instance of the wireless communications signal, that the first and second instances of the wireless communications signal are instances of the same wireless communications signal, and
detect the sensing target object based on the first and second instances of the wireless communications signal.

48. Circuitry for a second communications node for joint communication and sensing in a wireless communications network, the circuitry comprising
transmitter circuitry configured to transmit signals,
receiver circuitry configured to receive signals, and
controller circuitry configured in combination with the transmitter circuitry and the receiver circuitry to
determine a predefined time window for a first communications node of the wireless communications network, the pre-defined time window being after reception of a first instance of a wireless communications signal by the first communications node and being for the first communications node to determine that a second instance of a wireless communications signal is received by the first communications node within the pre-defined time window, the second instance of the wireless communications signal being a reflection of the wireless communications signal from a sensing target object, and/or
determine a predefined angular reception range for the first communications node, the predefined angular range being for the first communications node to determine that the second instance of the wireless communications signal was received by the first communications node after reception of the first instance of the wireless communications signal within the predefined angular range, and
transmit an indication of the predefined time window and/or the predefined angular range to the first communications node.

49.-51. (canceled)
